(19) United States
(12) Patent Application Publication
(10) Pub. No.: US 2003/0009345 A1
(43) Pub. Date: Jan. 9, 2003

(54) System and method for communication and processing of legal document based on geographic area

(76) Inventor: Kenneth J. Thorpe, Brooklyn, NY (US)

Correspondence Address: CHARLES E. BAXLEY, ESQUIRE, Hart, Baxley, Daniels & Holton, 59 John Street, Fifth Floor, New York, NY, 10038, US

(21) Appl. No.: 09/784,683

(22) Filed: Feb. 16, 2001

Related U.S. Application Data
(63) Continuation-in-part of application No. 09/617,826, filed on Jul. 17, 2000.

(51) Int. Cl. G06F 15/00

(52) U.S. Cl. 705/1

(57) ABSTRACT

A legal document processing system and method for processing legal documents between entities that use legal documents. The system includes a hub system for receiving legal documents from one entity and communicating them to another entity. The invention also includes a system and method for setting a geographic area within which a legal document will be delivered. The invention may also set the type of actor entity within the geographic area.

This application is a continuation-in-part of U.S. Ser. No. 09/617,826, currently pending.

### BACKGROUND OF THE INVENTION

1. Technical Field

The present invention relates generally to an electronic system for communicating and processing a legal document. More particularly, the invention relates to a system for communicating a legal document between attorneys or government agencies and financial institutions such as banks. Value added services are also built into the system. In particular, the system includes a mechanism for communicating a legal document to an entity based on geographic area.

2. Related Art

Legal documents are a mechanism by which legal entities, such as an attorney, law firm or government agency, communicate with others. Legal entities use a number of tools to complete tasks regarding legal documentation.

One tool commonly used by legal entities is a legal document template software package that creates a legal document by filling in fields in a template. The legal document is then printed for use. Conventionally, a legal document is then either hand delivered, mailed or faxed to an actor entity, e.g., a financial institution or law enforcement agency, that takes action based on the legal document. However, electronic filing of legal documents is becoming more attractive to reduce paperwork and provide instantaneous communication. Unfortunately, there is no adequate system available that both generates and communicates legal documents.

Other tasks that legal entities conduct daily are scheduling or docketing of legal document due dates and checking legal documents for compliance with current statutes/rules, e.g., prevention of duplication of documents that may be a violation of law. These tasks usually require a separate docketing software package. Compliance of a legal document with rules of actor entities is another challenge. Unfortunately, there is no single mechanism available for assuring compliance of a legal document with statutes/rules and actor entity rules.

Another tool used by legal entities is a database search system, e.g., Lexis-Nexis. Such tools also commonly require separate software to access and are usually not integrated into other systems.

Another challenge faced by legal entities that create legal documents is determining an appropriate recipient legal entity that can take action based on the legal document. For instance, an attorney may need to serve a garnishing order on a subject, but not know the subject's bank.

In view of the foregoing, there is a long felt need for a legal document processing system and method that integrates with database services, and can generate, assure compliance and electronically communicate legal documents. Further, there is a need for a mechanism for communicating a legal document to an entity based on its geographic proximity to a subject of the legal document.

### SUMMARY OF THE INVENTION

The invention is a legal document processing system and method for processing legal documents between entities that use legal documents. The system includes a hub system for receiving legal documents from one entity and communicating them to another entity. The hub system also makes available value added services that can be applied to a legal document such as statute and rule compliance. The invention also includes a document preparation system for selecting and preparing a legal document. The document preparation system can be a program on an entity system or a web site on the hub system. The system also includes a mechanism for communicating a legal document to an entity based on geographic area.

In a first aspect of the invention is provided a system for processing legal documentation, the system comprising: a hub system; a drafting entity system for preparing a legal document and communicating the legal document to the hub system; a geographic area subsystem including: an area selector for setting a geographic area within which an actor entity will receive the legal document; an actor entity determinator to determine the existence of an actor entity within the geographic area; and an actor entity system, located within the geographic area, that receives the legal document from the hub system.

A second aspect of the invention includes a method of communicating between entities that use legal documents, the method comprising the steps of: preparing a legal document on a first entity system; setting a geographic area within which the legal document will be communicated; communicating the legal document to a hub system; and communicating the legal document from the hub system to a second entity within the geographic area.

A third aspect of the invention includes a program product stored on a recordable medium, that when executed, comprises: means for creating a legal document; means for setting a geographic area within which the legal document will be delivered; and means for communicating the legal document to a hub system.

A last aspect of the invention includes a system for processing legal documentation between a drafting entity and an actor entity, the system comprising: a hub system including: a document preparation system for selecting a legal document and preparing the selected legal document for use, the document preparation system viewable on the client drafting entity system; and a geographic area subsystem viewable on a client drafting entity system, the geographic area subsystem including: an area selector for setting a geographic area within which an actor entity will receive the legal document; an actor entity determinator to determine the existence of an actor entity within the geographic area; and an actor entity system located within the geographic area that receives the legal document from the hub system.

The foregoing and other features and advantages of the invention will be apparent from the following more particular description of preferred embodiments of the invention.

### BRIEF DESCRIPTION OF THE DRAWINGS

The preferred embodiments of this invention will be described in detail, with reference to the following figures, wherein like designations denote like elements, and wherein:

FIG. 1 shows an exemplary legal document flow diagram of a system in accordance with the present invention;

FIG. 2 shows a block diagram of a hub system;

FIG. 3 shows a block diagram of a processing system of the hub system of FIG. 2;

FIG. 4 shows a block diagram of a drafting entity system;

FIGS. 5A-5D show dialogs of a document preparation system of the drafting entity system of FIG. 4;

FIG. 6 shows a block diagram of an actor entity system;

FIG. 7 shows an exemplary legal document flow from a drafting entity to an actor entity through the hub system;

FIG. 8 shows an exemplary legal document flow from an actor entity to a drafting entity through the hub system;

FIG. 9 shows a block diagram of a processing system of the hub system in accordance with an alternative embodiment;

FIG. 10 shows a block diagram of a drafting entity system in accordance with an alternative embodiment;

FIG. 11 shows a geographic area subsystem in accordance with an alternative embodiment; and

FIG. 12 shows a dialog of the geographic area subsystem of FIG. 11.

### DESCRIPTION OF THE PREFERRED EMBODIMENTS

For convenience, the description includes the following sections:

I. Legal Document Communication and Processing Model Overview

II. Hub System

A. Legal Document-Type Determinator Subsystem

B. Duplication Subsystem

C. Expiration Subsystem

D. Actor Entity Rule Subsystem

E. Verification Subsystem

F. Encryption/Decryption Subsystem

G. Search Engine Subsystem

H. NewsGroup start

III. Drafting Entity System

IV. Actor Entity System

V. Exemplary Legal Document Flows

VI. Geographic Area Subsystem

Although certain preferred embodiments of the present invention will be shown and described in detail for purposes of understanding the appended claims, it should be understood that one may practice the present invention in a variety of different embodiments as defined and covered by the claims.

I. Legal Document Communication and Processing Model Overview

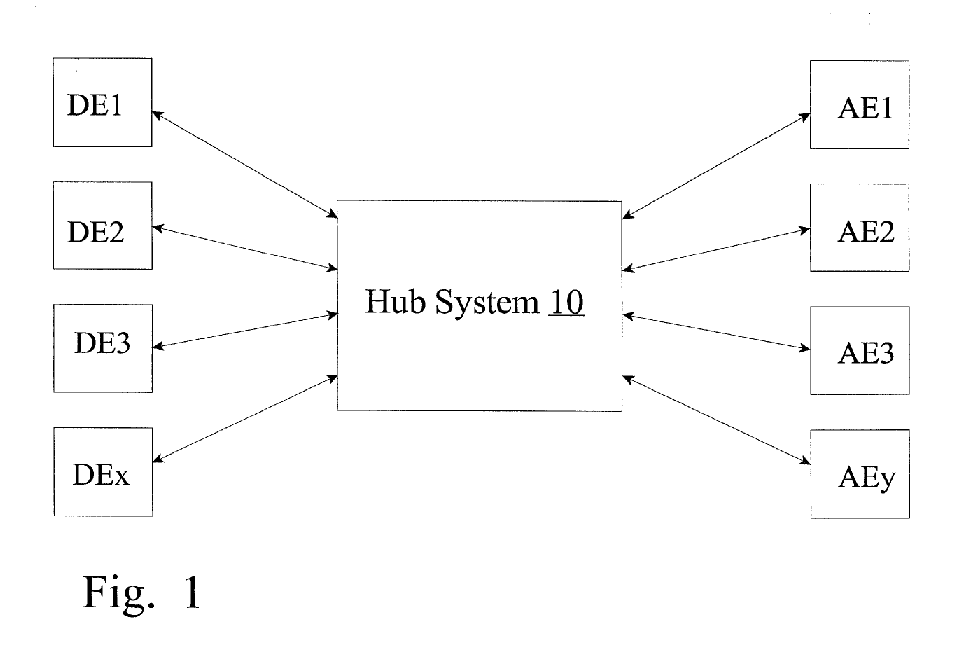

Referring to FIG. 1, a block diagram of a centralized, or hub, legal document communication and processing model of the present invention is shown. Hub system 10 provides a simplified interface for legal or drafting entities DE1-DEx and actor entities AE1-AEy to communicate, and additionally provides various value-added services as will be described below. Any number of drafting entities DE1-DEx and/or actor entities A1-Ay can easily join and use hub system 10, i.e., x and y are integers.

When a drafting entity creates a legal document, the drafting entity forwards it to hub system 10 for communication to an actor entity or actor entities. A “drafting entity” can be an attorney, a private law firm, a corporate counsel office, a government agency or any other individual or group of individuals that creates a legal document(s). An “actor entity” can be any type of individual or organization that takes action based on a legal document(s), e.g., a bank, a law enforcement agency such as marshal or a sheriff, a government agency such as a health department, etc. In other embodiments, either entity need not be a human or an organization, but rather may comprise, e.g., a digital agent, computer program, or specific-use computer programmed to automatically transmit/receive legal documents. For example, a drafting entity system may include an embedded system that can automatically create a legal document based on set criteria, e.g., not receiving a response from an actor entity regarding a previous legal document.

A legal document can contain any type of information being passed between a drafting entity and an actor entity, and vice versa from actor entity to drafting entity. “Legal documents” can contain electronically complete documents or electronic data components so a receiver of the data can create a document. Further, “legal documents” can be in hard copy form. Each legal document is transmitted in some format that has been previously approved by a committee relating to the particular field the legal document is used within. In some instances, the format is chosen by the actor entity. Examples of format are: a standardized electronic data interchange (EDI) format, email file, extensible markup language (XML), fax, flat file formats, etc. For convenience purposes, one or more legal documents may be physically grouped together by an entity or hub system 10 into “document files.” For the purpose of this disclosure, however, the terms “legal document” or “data” will be used for clarity.

The specific information in a legal document varies depending on the particular document and/or action being requested. Examples of common types of legal documents are: restraining orders, levies, subpoenas, full releases, warrants and any other type legal document known or hereafter developed. Most legal documents contain at least some base information such as a “subject” individual or organization to which the requested action relates. Similar to the transmittal format, the information contained in a particular type legal document is oftentimes predetermined by an oversight committee for the field to which the particular document relates. For example, the information contained in a levy may be decided by a committee containing judges, law enforcement officials, etc.

For description purposes, this disclosure will hereinafter refer to a single drafting entity DE and actor entity AE unless otherwise necessary. It should be recognized, however, that there can be any number of drafting entities and any number of actor entities in communication with hub system 10.

As will become evident, hub system 10 is capable of providing and enhancing data flow in either direction, i.e., in a drafting entity-hub-actor entity direction or in an actor entity-hub-drafting entity direction. For instance, a drafting entity may create a legal document that causes an actor entity to take some action, which action is confirmed by the communication of another legal document in response from the actor entity. Each drafting entity or actor entity may be referred to individually as an “entity” and collectively as “entities.”

As will be more apparent from the description that follows, entities may communicate legal documents and files to hub system 10 by a variety of means. One preferred embodiment includes inputting data to create legal documents directly into hub system 10 via a hub web page. Another preferred embodiment includes transmitting data for legal documents created at an entity system via a network to hub system. A preferred network includes a direct dial connection network. However, a variety of other networks may be possible such as the Internet, intranets, local area networks, wide area networks, telephone networks, wireless data transmission systems, two-way cable systems, a personal digital assistant, customized computer networks, interactive kiosk networks, email, and automatic teller machine networks.

II. Hub System

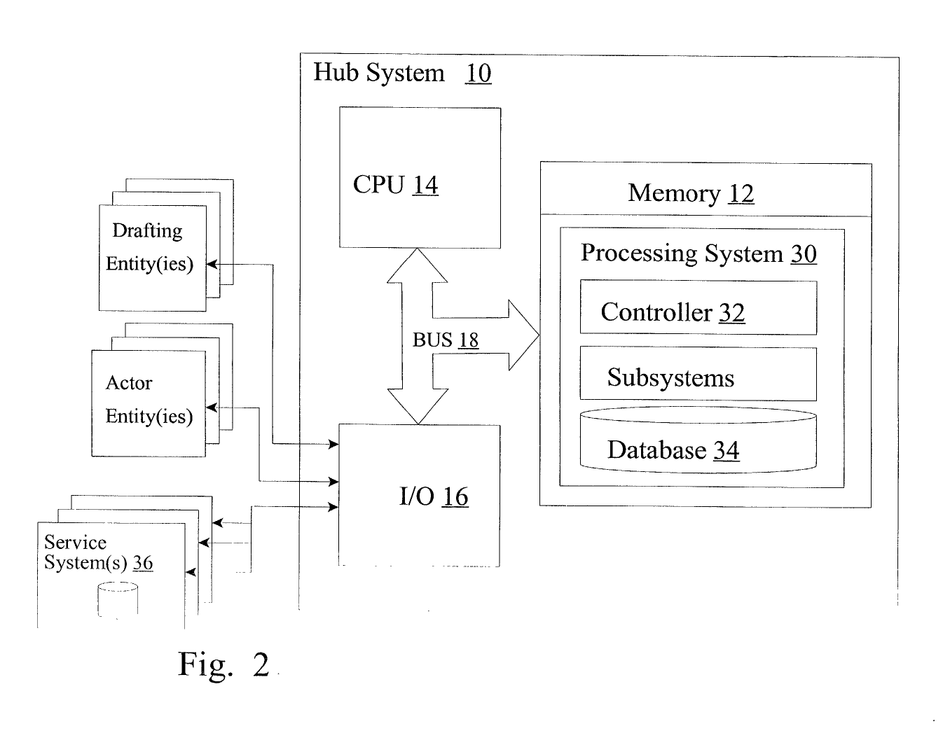

Referring now to FIG. 2, a hub system 10 depicting an embodiment of the present invention is shown. Hub system 10 comprises memory 12, a central processing unit (CPU) 14, input output (I/O) 16, and bus 18. Memory 12 may comprise any known type of data storage and/or transmission media, including magnetic media, optical media, random access memory (RAM), read-only memory (ROM), a data object, etc. Moreover, memory 12 may reside at a single physical location, comprising one or more types of data storage, or be distributed across a plurality of physical systems in various forms. CPU 14 may likewise comprise a single processing unit, or be distributed across one or more processing units in one or more locations, e.g., on a client and server. I/O 16 may comprise any known type of input output device, including, a network system, modem, keyboard, mouse, voice, monitor, printer, disk drives, etc. Bus 18 provides a communication link between the components in computer system 10 and likewise may comprise any known type of transmission link, including electrical, optical, radio, etc. In addition, although not shown, additional components, such as cache memory, communication systems, etc., may be incorporated into computer system 10.

It is understood that the present invention can be realized in hardware, software, or a combination of hardware and software. A hub system 10 according to the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls hub system 10 such that it carries out the methods described herein. The present invention can also be embedded in a computer program product, which comprises all the features enabling the implementation of the methods described herein, and which—when loaded in a computer system—is able to carry out these methods. Computer program, software program, or planning software, in the present context mean any expression, in any language, code or notation, of a set of instructions intended to cause a system having an information processing capability to perform a particular function either directly or after either or both of the following: (a) conversion to another language, code or notation; (b) reproduction in a different material form.

Stored in memory 12 is processing system 30. Processing system 30 comprises a controller 32, various subsystems, and a database 34. Processing system 30 communicates with drafting entities and/or actor entities and service systems 36 via bus 18 and I/O 16.

Database 34 may include data stored locally in one or more storage devices, such as a magnetic disk drive or an optical disk drive. In another preferred embodiment, database 34 includes data distributed across a local area network (LAN), a wide area network (WAN) or a storage area network (SAN) (not shown). Database 34 may also be configured in such a way that one with ordinary skill in the art may interpret it to include many databases.

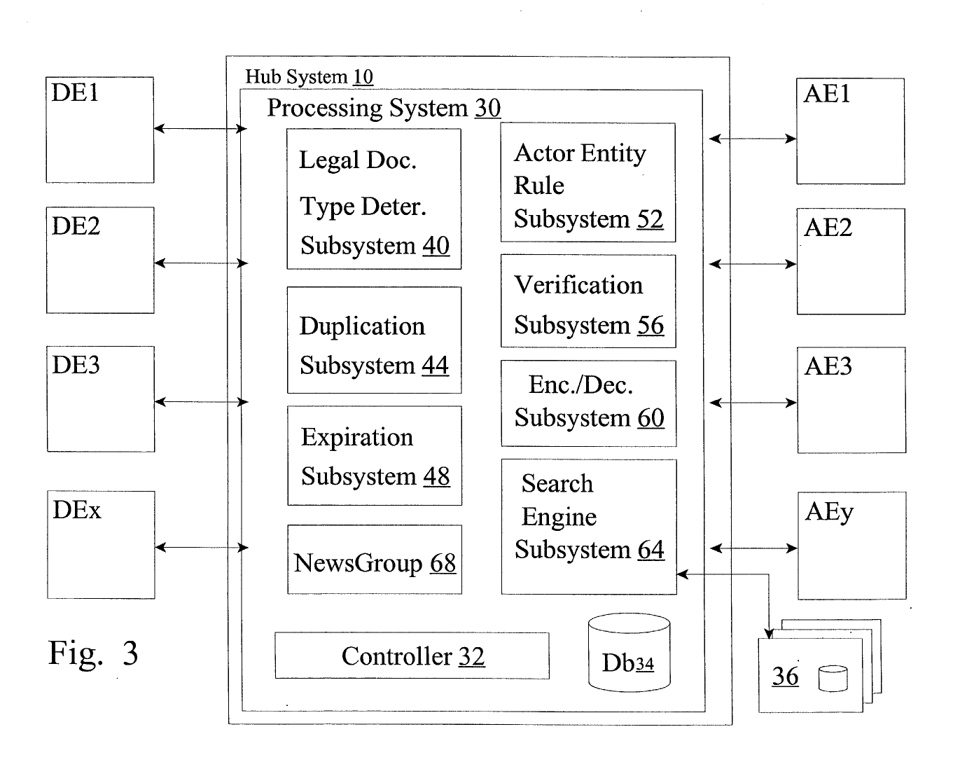

As shown in further detail in FIG. 3, processing system 30 generally includes a controller 32, database 34 and the following subsystems: a legal document-type determinator subystem 40, a duplication subsystem 44, an expiration subsystem 48, an actor entity rule subsystem 52, a verification subsystem 56, an encryption/decryption subsystem 60, a search engine subsystem 64, and a newsgroup 68.

Controller 34 controls operation of subsystems within processing system 30. Legal document-type determinator subsystem 40 is responsible for determining the type of legal document when necessary. Duplication subsystem 44 determines whether a legal document is a duplicate. Expiration subsystem 48 determines whether a legal document effectiveness has expired. Actor entity rule subsystem 52 verifies an outgoing legal document is in compliance with an actor entity's requirements. Verification subsystem 56 determines whether all of a legal document has been received. Encryption/decryption subsystem 60 provides secure communication. Search engine subsystem 64 provides a mechanism to access service systems 36 and their databases for information pertinent to legal documents. Newsgroup 68 allows entities to communicate with hub system 10 to, for example, provide suggestions to improve hub system 10.

Legal documents that pass through hub system 10 are saved in database 34 for safe keeping and accessed by the subsystems to be described below. Database 34 may also save data for batch processing with a service system 36. Data for a government employee database service is one example of information that is saved for periodic processing.

A. Legal Document-Type Determinator Subsystem

When hub system 10 receives a legal document, hub system 10 may activate a legal document-type determinator subsystem to determine the type of legal document. The type of legal document may also be apparent from the data being communicated. One mechanism that would allow for determination of the type of legal document may be a code attributable to each legal document. As one with ordinary skill in the art will recognize, there are a number of different ways for determinator subsystem 40 to operate, all of which should be considered within the scope of this invention.

The determination of the type of legal document may be necessary to indicate to processing system 30 what other subsystems require activation. For instance, a restraining order type legal document is a type of document that may expire. Accordingly, receiving a restraining order may trigger processing system 30 to activate expiration subsystem 48, as will be described in more detail below.

B. Duplication Subsystem

Duplication subsystem 44 reviews database 34 to determine whether more than one of the same legal document has been submitted to hub system 10, a situation which may represent an illegal operation by a drafting entity. Duplication subsystem 44 may make a determination by checking data for duplications based on a document identifier, i.e., an identifier associated with each legal document, or a drafting entity identifier, i.e., a drafting entity identifier.

When a duplicate legal document is found, the duplicate can be deleted and a message communicated to the drafting entity indicating the same. Legal documents that are submitted as amendments to previously submitted legal documents will not be deleted.

C. Expiration Subsystem

Expiration subsystem 48, as briefly mentioned earlier, monitors certain types of legal documents to determine whether the efficacy of such documents has expired. For instance, a restraining order may have a time-limited enforcement period. Expiration subsystem 48 would scrutinize expiration of legal documents by monitoring an entry date of the legal document versus a known effectiveness period for such a document. Alternatively, an expiration date may be entered with other data as the legal document is created. When expiration is to occur, expiration subsystem 48 would alert the appropriate entity ahead of time so appropriate action could be taken.

D. Actor Entity Rule Subsystem

Actor entity rule subsystem 52 evaluates a legal document prior to it being communicated to an actor entity to determine whether predetermined rules of the actor entity have been followed. For instance, a particular actor entity may require that a legal document lists a subject by last name then first name. When a rule has been violated, a message may be communicated to the submitting drafting entity for correction.

E. Verification Subsystem

Verification subsystem 56 determines whether all of a legal document was properly transmitted. While one with ordinary skill in the art will recognize that there are variety of mechanisms available to verify data. For example, check-sum processing, error checking processing, etc.

F. Encryption/Decryption Subsystem

Encryption/decryption subsystem 56 provides security to communications to and from hub system 10. Almost all legal documents are considered confidential and require some form of security. In a preferred embodiment, hub system 10 employs both public-key and private-key cryptosystems to maximize both security and system performance. Subsystem 56 may also provide 128-bit encryption/decryption and logon identifiers with password.

Encryption/decryption subsystem 56 may also provide compression functionality.

G. Search Engine Subsystem

Search engine subsystem 52 provides a number of value added services to hub system 10 by allowing hub system 10 to access a variety of service systems 36 outside of hub system 10. Service systems 36 may provide information or provide some service based on a legal document or information therein. Among preferred service systems 36 are: a bankruptcy database service, a real property database service, a skip search/address-finder database service 54, a government employee database service 56, and a law enforcement official database service. The bankruptcy, real property, government employee and skip search/address-finder services would search their respective databases for information on a particular subject individual or organization. A bankruptcy service is beneficial, for example, to prevent submission of a garnishing order to a bank for an account that is unaccessible because the owner is bankrupt. A real property service is advantageous, for example, to determine what assets a debtor may own. A government employee service allows a drafting entity to determine whether a person is a government employee, which may provide for special treatment in some circumstances. A skip search/address-finder service is helpful, for example, to find individuals or organizations that move to avoid liability, i.e., they “skip town.”

A law enforcement official service would identify the appropriate law enforcement official to receive a legal document where that information is not already known. The legal document could then be automatically forwarded to that official. A levy is an example of where this type service is advantageous because a levy must be sent to a marshal or sheriff for execution. When the official is unknown to the drafting entity, this service saves time and effort by coupling the information to the levy for continued processing and communicating such to the drafting entity.

With any of the above described services, hub system 10 could communicate an appropriate message to the drafting entity regarding what information was found and whether the legal document in question proceeded through processing with the added information.

A drafting entity can either preset the services to be provided on a legal document or select the services from the drafting entity system to be described below. For instance, for a levy, a drafting entity may request a determination of whether a subject of the levy is: bankrupt, a property owner, a government employee or has moved to avoid liability. Search engine subsystem 52 would then access the appropriate service systems, provide the requested data to the drafting entity and continue processing, if possible.

Accessing of service systems 36 may be provided on a document-by-document basis or can be processed in batch form. As discussed above, the government employee database service is one example of where data may preferably be saved in database 34 for batch processing.

H. Newsgroup

A newsgroup 68 is provided on hub system 10 as an added mechanism to collect information from users regarding improvements and for users to communicate with each other.

III. Drafting Entity System

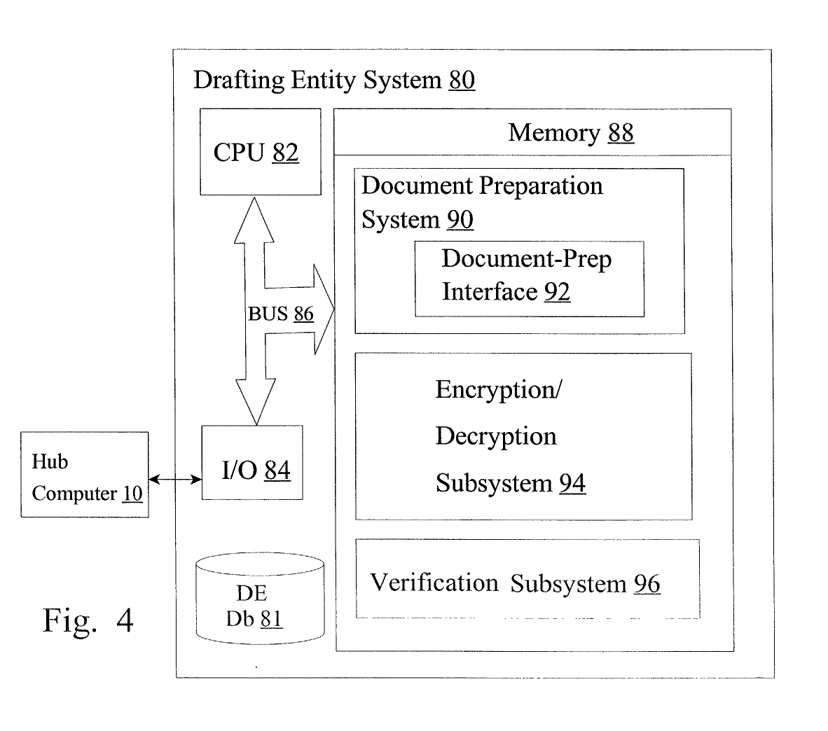

The invention includes a drafting entity system 80, shown in FIG. 4. Drafting entity system 80 includes a drafting entity database 81, a CPU 82, input output (I/O) 84, bus 86, a memory 88, a document preparation system 90 having a document-prep interface 92, an encryption/decryption subsystem 94 and a verification subsystem 96. With regard to the particular components, structure, software/hardware form and location of CPU 82, I/O 84, bus 86 and memory 88, the comments stated above relative to hub system 10 are equally applicable to drafting entity system 80. For example, system 80 need not be a separate system, e.g., system 80 could be a client, dumb terminal of hub system 10.

Document preparation system 90 provides a mechanism for a user, e.g., a drafting entity, to select a legal document(s) to be created, generate the legal document(s), choose an actor entity or entities to receive a legal document(s), print the legal document s) and accurately and securely communicate legal document(s). In a preferred embodiment, document preparation system 90 has a graphical user interface 92 accessible as a desktop application on drafting entity system 80. However, another preferred embodiment, as will be described below, provides document preparation system 90 as a graphical user interface accessible as a web site associated with hub system 10. In this case, system 90 would be viewable from a secure web browser, such as Netscape Communicator or Microsoft Internet Explorer, on client drafting entity system 80. System 90 may also be downloadable from a web site associated with hub system 10.

With special regard to input, data can be entered for document preparation system 90 manually through a keyboard. Alternatively, input may be provided by a program for importing data from another file. For instance, information on a certain subject that is used repeatedly may initially be input into a subject file for use with multiple legal documents and accessed by an import program.

In terms of output, I/O 84 of drafting entity system 80 may communicate data to hub system 10 or a printer. If a drafting entity knows that a particular actor entity is a user of hub system 10, communication of legal documents to hub system 10 is the most efficient way of communicating. As noted above, communication may take a variety of forms. A preferred network includes a direct dial connection network. However, a variety of other networks may be possible such as the Internet, intranets, local area networks, wide area networks, telephone networks, wireless data transmission systems, two-way cable systems, a personal digital assistant, customized computer networks, interactive kiosk networks, email, and automatic teller machine networks.

When a drafting entity does not know whether a particular actor entity is a user of hub computer system 10, drafting entity system 80 also allows hard copy legal documents to be generated using a printer for flat document communication to an actor entity, e.g., U.S. postal service mail, fax, overnight delivery, etc.

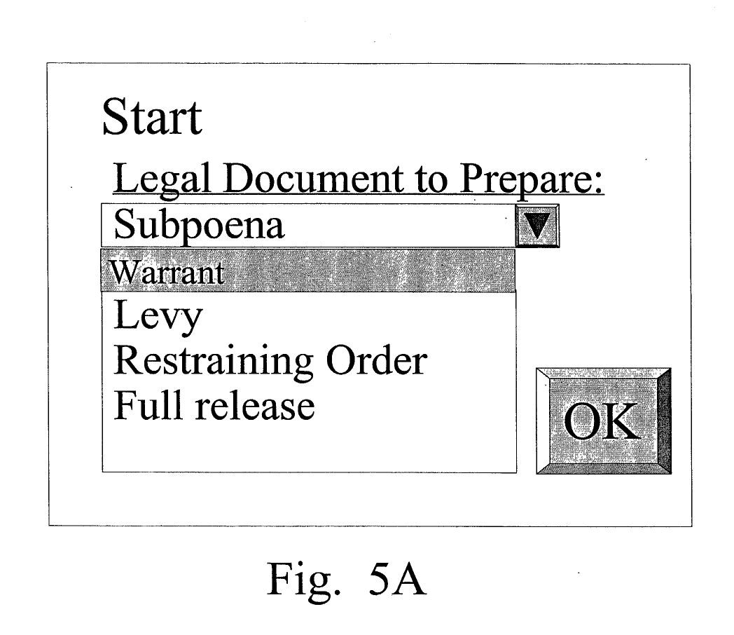

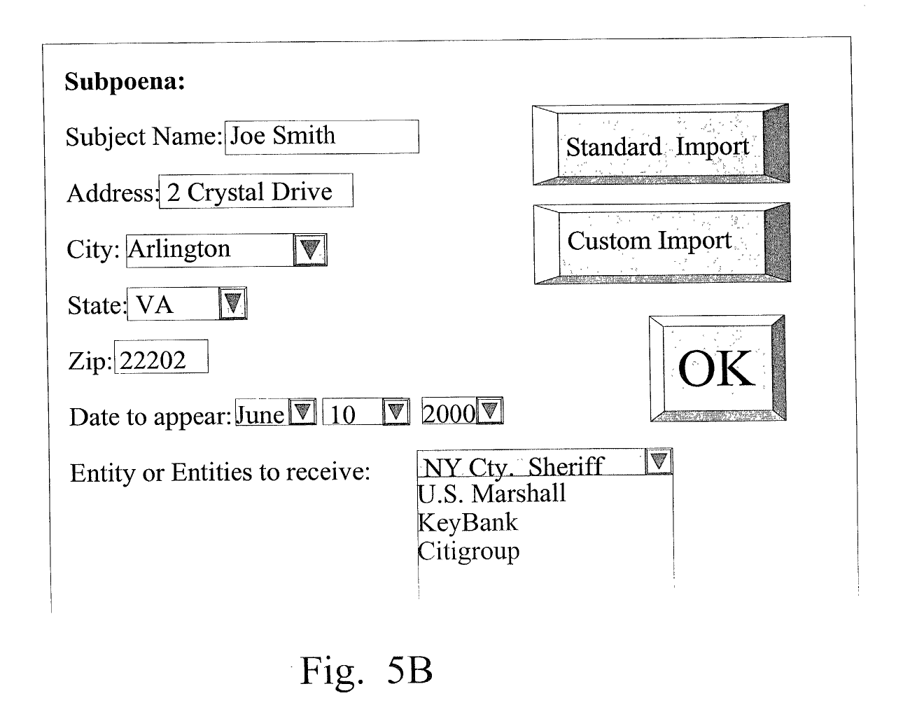

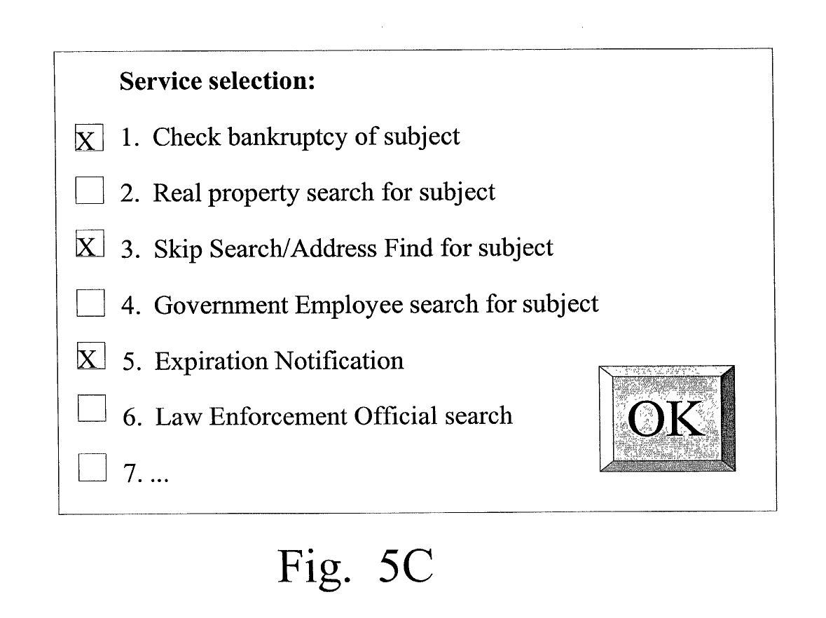

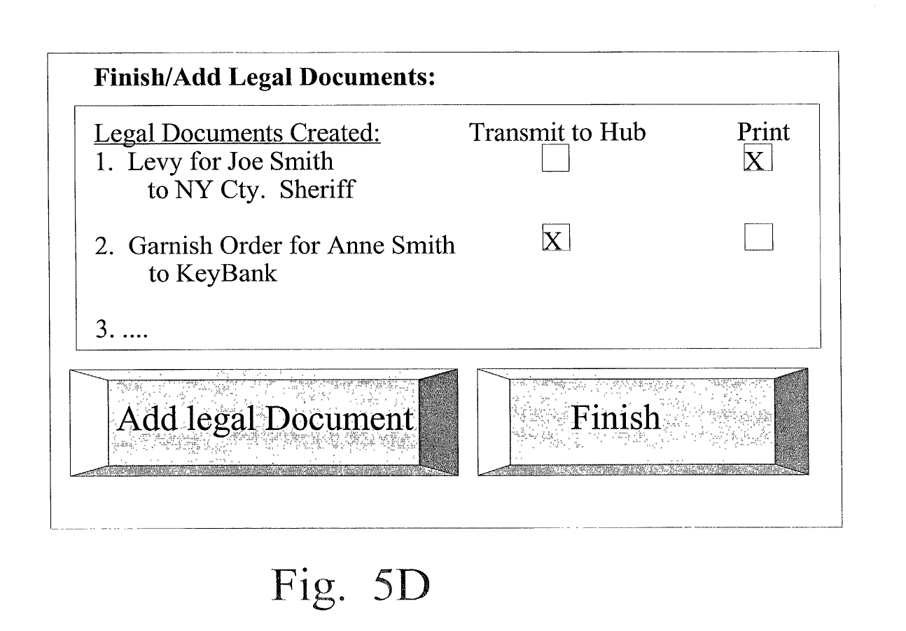

Referring to FIGS. 5A-5D, a preferred embodiment of dialogs of legal document preparation system 90 are disclosed. While a particular preferred embodiment of dialogs will be disclosed, it should be recognized that system 90 may include a number document-prep dialogs for selection and activation of system 90 and not depart from the spirit of the invention.

FIG. 5A shows a legal document-prep Start dialog 100 in which a user may select the type of document to be prepared. As indicated, start window 100 includes a drop-down selection list 102 of possible legal documents that can be generated. Upon activation of system 90, a user will come to this start dialog and select which document he/she would like to create. Selecting of the “OK” button indicates a user is ready to proceed.

Once a legal document has been selected, an appropriate input dialog 106, shown in FIG. 5B, for the legal document chosen is provided. The dialog shown is for a subpoena. Each legal document's dialog may be different. For instance, because a restraining order may include an expiration date, an entry dialog may be provided to enter that date. A user may manually enter data into the selected legal document using a keyboard or may select to import information. In the latter case, selection buttons for a “standard import” or a “custom import” may be provided. A “standard import” may import data regarding a known set of data for a particular type legal document, e.g., levy for NY County. A “custom import” may allow a user to import selective data, e.g., data selected from another dialog or a file.

Once the data for a legal document has been inputted, a drafting entity may select an appropriate actor entity or entities to receive the legal document from a drop-down selection list 108. In a preferred embodiment, the actor entities available are periodically updated. It should be recognized that if data is imported, it may include actor entity information such that drop-down selection list 108 may be omitted. When complete, a user may select “OK” to proceed.

Once data input is complete, as shown in FIG. 5C, a Service Selection dialog 110 may be provided for a user to select services that can be provided by hub computer system 10. Services may be provided within hub system 10 through the subsystems described above or through search engine subsystem 64 accessing other service systems 36 and their databases. Preferred choices of services are: check bankruptcy of subject, real property search for subject, skip search/address find for subject, government employee search for subject, expiration notification, law enforcement official search, etc. If a particular service is inappropriate for a selected legal document, it may be omitted or unselectable at this dialog. When complete, a user may select “OK” to proceed. time of completion, the legal document(s) would also be saved to a drafting entity database 81, shown in FIG. 4, for later access by the drafting entity.

Returning to FIG. 4, if the legal documents are to be communicated to hub system 10 for delivery to actor entity or actor entities, an encryption/decryption sub-system 94 of drafting entity system 80 would be activated to encrypt the data using, e.g., 128-bit encryption. Encryption/decryption system 94 may also implement conventional compression techniques on the data.

A verification system 96 (e.g., check-sum) is provided as part of drafting entity system 80 for verifying all of a transmission has been received when legal documents are communicated to the drafting entity.

As an alternative to drafting entity system 80 being a separate system, hub system 10 may also support direct entry of data via a hub system website. In this case, a user would directly access a hub system website without any desktop functionality other than a secure web browser. The web site would provide dialogs similar to those shown in FIGS. 5A-5D. In this case, security would be provided via domestic grade secure socket layers, e.g., 128-bit SSL. Legal documents would also be saved to a drafting entity database 81 for later access.

IV. Actor Entity System

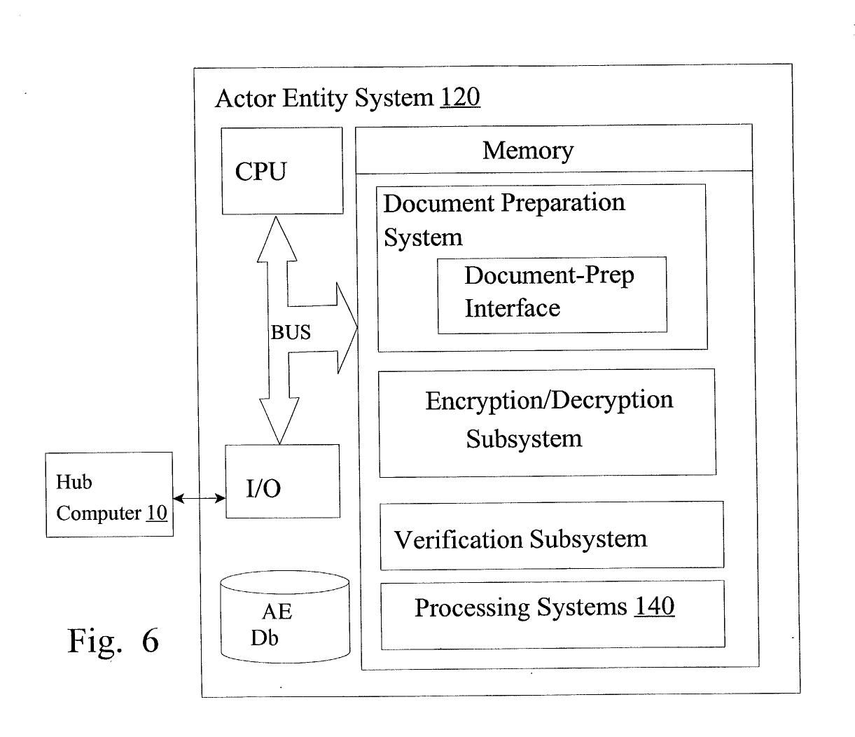

Referring to FIG. 6, an actor entity system 120 may be provided that is similar to drafting entity system 80. With regard to the particular components, structure, software/hardware form and location of the CPU, I/O, bus and memory of actor entity system, the comments stated above relative to hub system 10 and drafting entity system 80 are equally applicable to actor entity system 120. Furthermore, the statements made above relative to the form and location of document processing system 90 are also equally applicable to the actor entity's document processing system.

A document processing system of actor entity system 120 provides the same functions as described above relative to drafting entity system 90. A difference that may be present between the two systems is the type of legal documents that are available. For instance, an actor entity may use “response documents” that communicate information regarding legal documents such as deficiencies, incorrect addresses, unexecutable levies, etc. An actor entity system 120 may also include other processing systems 140 particular to the actor entity, e.g., a bank may have financial account tracking software.

V. Exemplary Legal Document Flows

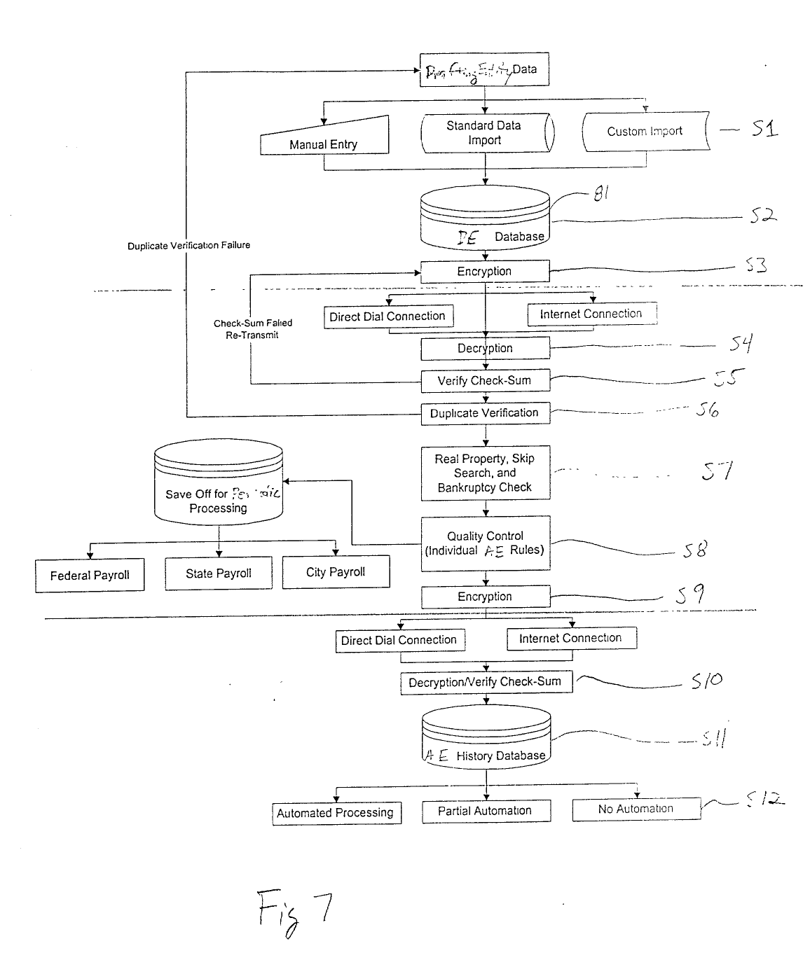

Referring to FIG. 7, an exemplary legal document flow from a drafting entity to an actor entity through hub system 10 is shown. As shown in step S1, data may be input according to the above description into drafting entity system through manual entry, standard data import or a custom import.

Next, at step S2, legal documents are saved to drafting entity database 81.

At step S3, legal documents are encrypted for transmission to hub computer system 10.

At step S4, legal documents are communicated to hub system 10 by any of a variety of networks as described above. A direct dial connection and Internet connection are shown as possibilities.

At step S5, verification subsystem 56 of hub system 10 is activated to determine whether all of the data transmitted from drafting entity was received. If the verification fails, a message is sent to drafting entity system to re-transmit. It should be recognized that where a user enters data into a hub computer web site, the encryption of data followed by communication and verification may be omitted because of the direct entry of information.

At step S6, duplication subsystem 44 of hub system 10 is activated to determine whether the legal document(s) received is a duplicate of a previously received legal document. This check prevents drafting entity from potentially violating laws prohibiting communication of duplicate, repetitive or unnecessary legal documents. If the received legal document is found to be a duplicate, a notification message is communicated to the drafting entity and the duplicate legal document is rejected. Duplication subsystem 44 also determines whether a legal document is an amendment of a prior legal document and will not reject these documents.

At step S7, any service(s) that is selected (or otherwise predetermined to be performed) by drafting entity will be conducted. This step entails activating search engine subsystem 64 of hub system 10 to access service systems 36 to investigate requested information such as bankruptcy, address, and real property ownership.

At step S8, actor entity rule subsystem 52 of hub system 10 is activated to investigate compliance with the requirements or rules of the actor entity that is to receive the legal documents. If the legal document does not violate any rule, processing continues. If the legal document does violate a rule, it is sent back to the drafting entity for review and update. At this time, data may also be saved to hub system database 34 for a periodic processing, e.g., a batch processing with government employee search service. The investigation of whether the subject is a government employee is conducted by search engine subsystem 64 accessing government payroll information, e.g., city, state and/or federal.

At step S9, the data is encrypted and either set aside for a suitable time for an actor entity to access the information or is communicated to the actor entity.

At step S10, data is received at an actor entity, decrypted and verified.

At step S11, data is stored at an actor entity database.

Finally, at step S12, the legal document is subject to processing at the actor entity either through automated, partially automated or non-automated processing.

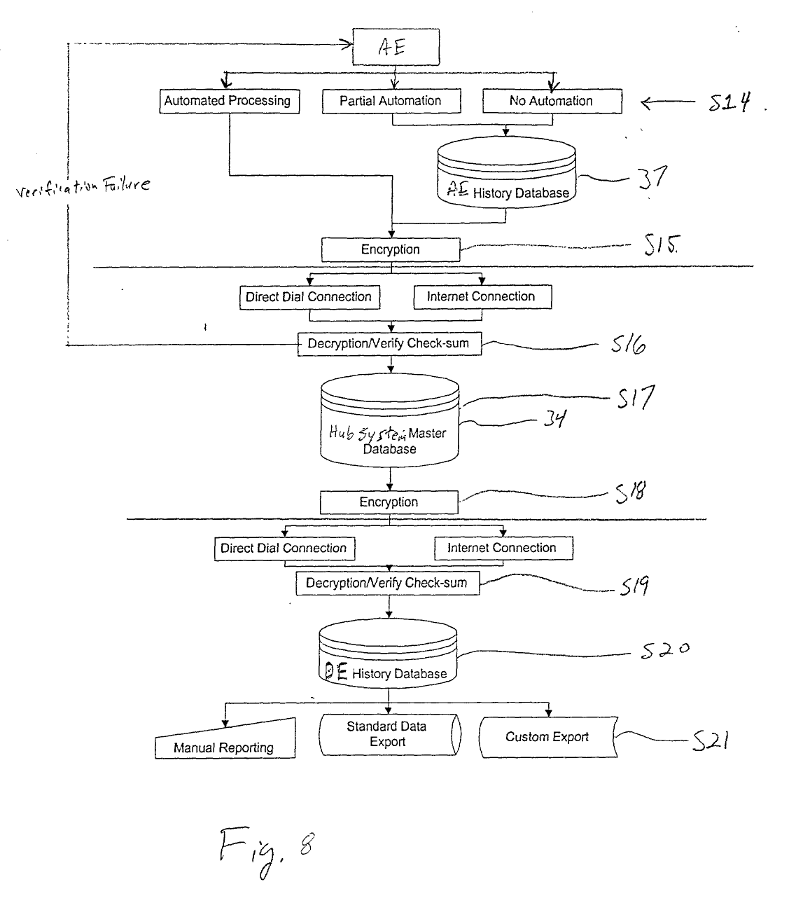

Referring to FIG. 8, an exemplary legal document flow from an actor entity to a drafting entity through hub system 10 is shown. The data flow is fairly similar to that of data from a drafting entity except service systems 36 are not accessed.

At step S14, an actor entity data is processed, i.e., automated, partially automated or non-automated at an actor entity system 120. The data may be stored at an actor entity database.

At step S15, the data is encrypted for transmission to hub system 10.

At step S16, data is received at hub system 10, decrypted by encryption/decryption subsystem 60 and verified by verification subsystem 60 for completeness. If the submission does not contain all the necessary information, it is sent back to the actor entity for review and update.

If all of the required information is present, it is then saved to hub system database 34 at step S17.

At step S18, data is encrypted by encryption/decryption subsystem 60 for communication to an appropriate drafting entity.

At drafting entity, data is decrypted/verified, step S19, and stored to drafting entity database 81, step S20.

Finally, at step S21, a drafting entity may act upon the data by conducting, for example, manual reporting, standard data export or a custom export.

VI. Geographic Area Subsystem

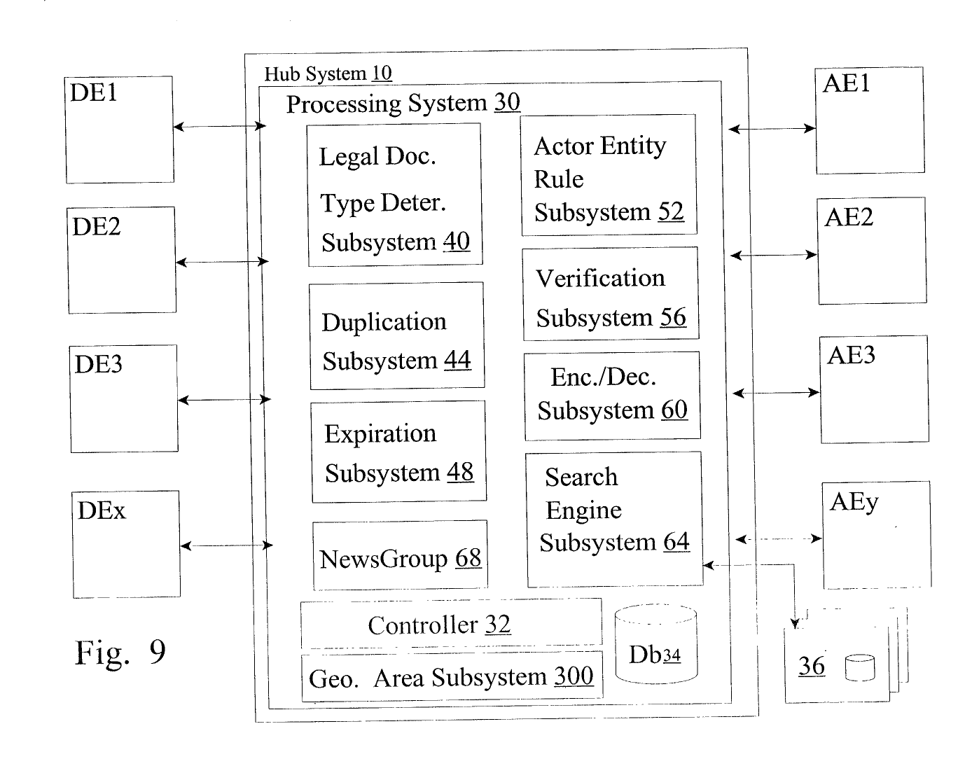

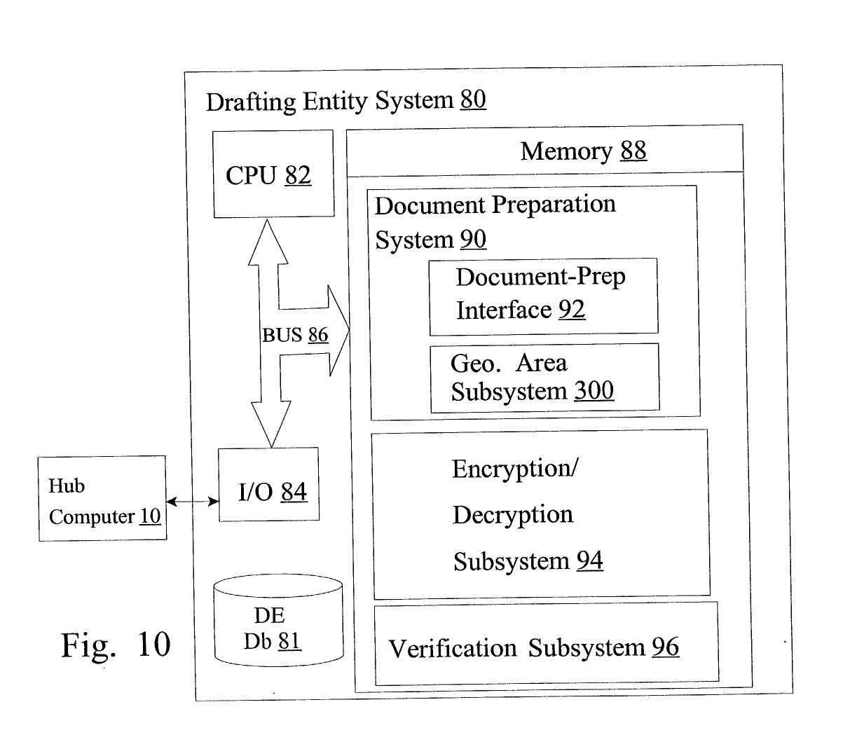

Referring to FIGS. 9-12, in an alternative embodiment of the invention, a geographic area subsystem may be provided. Geographic area subsystem 300 (FIGS. 9 and 10) provides a mechanism by which a user may select a geographic area within which an actor entity will receive the legal document. This subsystem finds advantage, for example, when a bank at which a subject of a legal document has an account is unknown.

As shown in FIGS. 9 and 10, geographic area subsystem 300 can be provided as part of hub system 10 (preferred) or drafting entity system 80. In the latter case, geographic subsystem 300 is preferably provided as part of document preparation system 90.

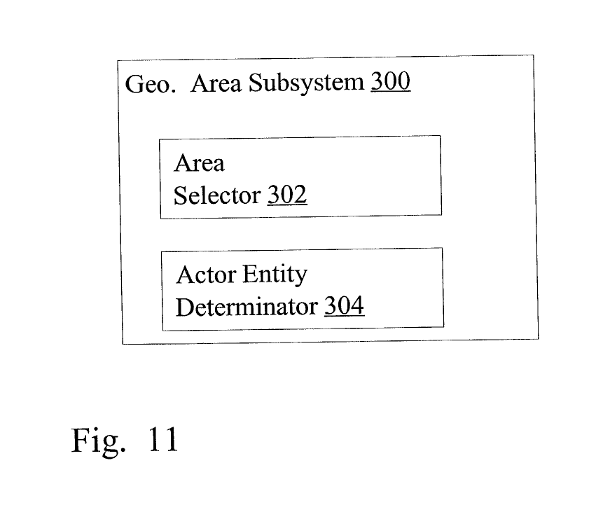

As shown in FIG. 11, geographic area subsystem 300 includes an area selector 302 for setting a geographic area within which an actor entity will receive the legal document and an actor entity determinator 302 that determines the existence of an actor entity within the geographic area.

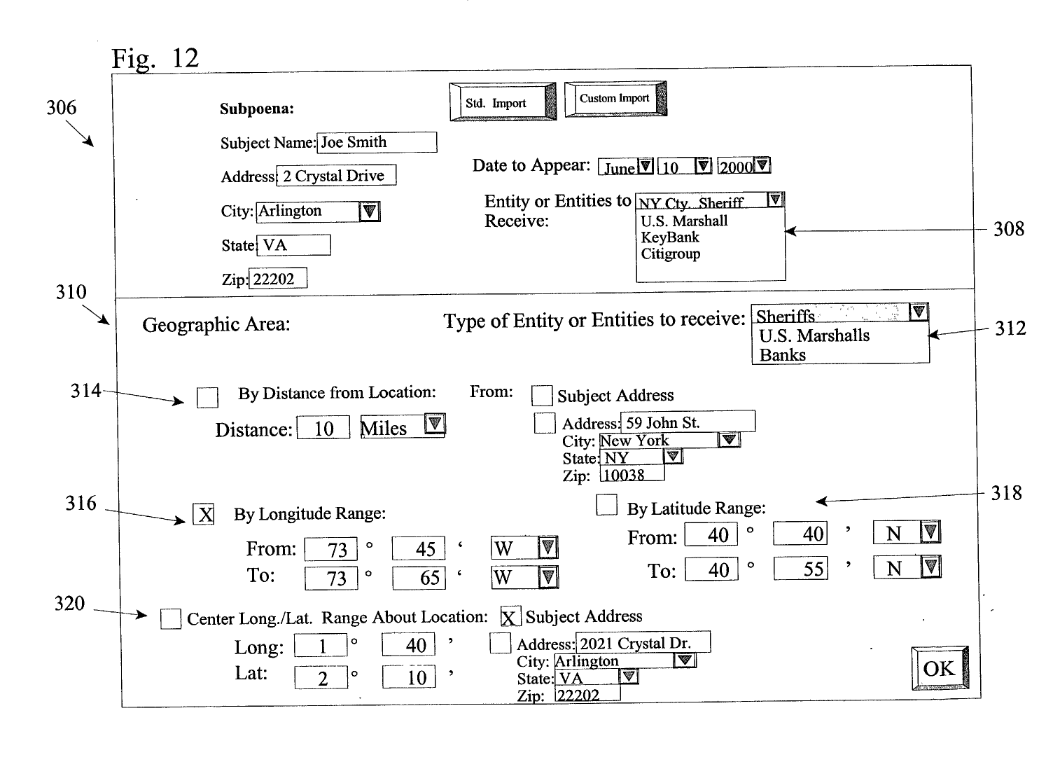

Referring to FIG. 12, an alternative input dialog 306 for a selected legal document is shown. Input dialog 306 would replace input dialog 106 of FIG. 5B, described above, where geographic area subsystem 300 is provided. Similar to dialog 106, the input dialog 306 illustrated is for a subpoena. However, as with input dialog 106, each legal document's input dialog 306 may be different. For instance, in the case of a subpoena, only the Date to Appear is provided. However, a restraining order may include an expiration date entry dialog. A user may manually enter data into the selected legal document using a keyboard or may select to import information. In the latter case, selection buttons for a “standard import” or a “custom import” may be provided. A “standard import” may import data regarding a known set of data for a particular type legal document, e.g., levy for NY County. A “custom import” may allow a user to import selective data, e.g., data selected from another dialog or a file.

As described above, once the data for a legal document has been inputted, a drafting entity may select an appropriate actor entity or entities to receive the legal document from a drop-down selection list 308. As shown in FIG. 12, in accordance with the alternative embodiment, a drafting entity may instead choose delivery based on geographic area using geographic area input section 310.

In terms of drop-down selection list 308, in a preferred embodiment, the actor entities available are periodically updated. It should be recognized that if data is imported, it may include actor entity information such that drop-down selection list 308 may be omitted.

In terms of geographic area input section 310, a drafting entity first selects the type of entity or entities within a geographic area that will receive the legal document at selection 312. The list of actor entities available are periodically updated and may be more generic than those of drop-down selection list 308, e.g., ‘sheriffs’ as opposed to ‘NY Cty. Sheriff’. A reason that the list may be more generic is that it may be beneficial to select every type of actor entity within a geographic area when the most appropriate actor entity is not known. One example of where this is advantageous is where a garnishing order must be served on a debtor subject's bank, but the actual bank is unknown. Using a more generic descriptor such as ‘Banks’, allows geographic subsystem 300 to deliver the legal document to every bank within a geographic area that is suspected as encompassing the subject's actual bank, e.g., an area close to his/her residence, place of business, etc. Although the available actor entities may be more generic, it should be understood that they may also have a wide range of specificity. For example, if a debtor subject is known to use a First Union® bank but the actual branch is unknown, a selection for that particular commercial bank may be available.

Next, a drafting entity may select the basis for the geographic area. In the exemplary input dialog 306, four basis for setting the geographic area are shown: by distance from a location 314, by longitude range 316, by latitude range 318 and a range of longitude and/or latitude about a location 320. It should be recognized, however, that any form of setting a geographic area is considered within the scope of the invention. Other examples may include, inter alia: zip code, area code, municipality such as city or village, county, state.

Where a drafting entity chooses to set a geographic area by a distance from a location 314, the distance parameter, e.g., 10, and distance measurement, e.g., miles, may be set followed by the location. The location may be set to the subject address as initially entered/imported and/or another address, e.g., 59 John Street, New York, N.Y. 10038.

Where a drafting entity chooses to set a geographic area using longitude and latitude, the area may be set by providing a longitude range 316, e.g., from 73 degrees, 45 minutes West to 73 degrees, 65 minutes West, and/or a latitude range 318, e.g., from 40 degrees, 40 minutes North to 40 degrees, 55 minutes North. A drafting entity may also select to set a geographic area using longitude and/or latitude by setting a range of longitude and/or latitude about a location 320. For example, 1 degree, 40 minutes longitude and 2 degrees, 10 minutes about the subject address. The location may be set to the subject address as initially entered/imported and/or another address, e.g., 2021 Crystal Drive, Arlington, Va. 22202.

As illustrated, a location is preferably provided in the form of an address. However, it should be recognized that a location may be provided in a variety of ways. For example, by longitude and latitude, by telephone number, etc. Further, location need not be specific. For example, location may be presented in the form of a city block, a neighborhood, etc.

While particular ways of setting a geographic area have been illustrated, the following should be understood. First, the ways illustrated are not necessarily mutually exclusive. That is, a drafting entity may select one or more geographic areas by, e.g., setting an area by distance from a location and by longitude range. Second, any way of setting a geographic area may be duplicated such that one or more geographic areas may be set. For example, two geographic areas may be set by distance from a location by entering subject address and an additional address. If necessary, additional entry dialogs for addresses and/or ranges may be provided for the illustrated ways of setting a geographic area. In this way, a drafting entity may have the legal document delivered to a number of geographic areas that are suspected of encompassing an appropriate actor entity for the legal document.

When the drafting entity has completed entering data, the “OK” button may be selected to proceed. Geographic area subsystem 300 then activates actor entity determinator 304 to determine the existence of an actor entity within the geographic area(s). Each actor entity that matches the type of entity/entities chosen by the drafting entity and within the geographic area(s) will receive the legal document. In the case that geographic area subsystem 300 is provided as part of drafting entity system 80, instructions on where to deliver the legal document may be communicated to hub system 10 with the legal document. For example, a list of actor entity addresses determined may be forwarded to hub system 10 or each actor entity determined may have its own legal document created. In the case that geographic area subsystem 300 is provided as part of hub system 300, the legal document is delivered to each actor entity determined to be within the geographic area(s).

The invention also includes a method of communicating between entities that use legal documents comprising the steps of: preparing a legal document on a first entity system; setting a geographic area within which the legal document will be communicated; communicating the legal document to a hub system; and communicating the legal document from the hub system to each second entity within the geographic area

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. For instance, while the systems of the invention have been described as separate objects, it is considered within the scope of the invention for the systems to be integrated with other systems and applications used by the described entities.

We claim:

1. A system for processing legal documentation, the system comprising:
a hub system;
a drafting entity system for preparing a legal document and communicating the legal document to the hub system;
a geographic area subsystem including:
an area selector for setting a geographic area within which an actor entity will receive the legal document;
an actor entity determinator to determine the existence of an actor entity within the geographic area; and
an actor entity system, located within the geographic area, that receives the legal document from the hub system.

2. The system of claim 1, wherein the area selector allows selection of a type of actor entity that will receive the legal document.

3. The system of claim 1, wherein the area selector sets the geographic area based on a distance from a location.

4. The system of claim 3, wherein the location is an address.

5. The system of claim 1, wherein the area selector sets the geographic area based on at least one of a range of longitude and a range of latitude.

6. The system of claim 5, wherein the at least one of a range of longitude and a range of latitude are set about a location.

7. The system of claim 6, wherein the location is an address.

8. The system of claim 1, wherein the geographic area subsystem is part of the hub system.

9. The system of claim 1, wherein the geographic area subsystem is part of the drafting entity system.

10. The system of claim 1, wherein the actor entity system is chosen from the group comprising: a financial institution system and a law enforcement agency system.

11. The system of claim 1, wherein the hub system includes an input/output for communicating data to and from the actor entity system, and to and from the drafting entity system.

12. The system of claim 1, wherein the hub system includes a verification subsystem that checks data for completeness.

13. The system of claim 1, wherein the hub system includes an actor entity rule subsystem that checks the legal document based on rules of the actor entity system to receive the legal document.

14. The system of claim 1, wherein the hub system includes a duplication subsystem that determines whether the legal document is a duplicate.

15. The system of claim 1, wherein the hub system includes a search engine subsystem for accessing a service system outside the hub system.

16. The system of claim 1, wherein the hub system includes an expiration system for monitoring expiration of the legal document.

17. The system of claim 1, wherein the hub system includes a legal document type determinator.

18. A method of communicating between entities that use legal documents, the method comprising the steps of:
preparing a legal document on a first entity system;
setting a geographic area within which the legal document will be communicated;
communicating the legal document to a hub system; and
communicating the legal document from the hub system to a second entity within the geographic area.

19. A program product stored on a recordable medium, that when executed, comprises:
means for creating a legal document;
means for setting a geographic area within which the legal document will be delivered; and
means for communicating the legal document to a hub system.

20. The program product of claim 19, further comprising means for selecting a type of entity that will receive the legal document within the geographic area.

21. A system for processing legal documentation between a drafting entity and an actor entity, the system comprising:
a hub system including:
a document preparation system for selecting a legal document and preparing the selected legal document for use, the document preparation system viewable on a client drafting entity system; and
a geographic area subsystem viewable on the client drafting entity system, the geographic area subsystem including:
an area selector for setting a geographic area within which an actor entity will receive the legal document;
an actor entity determinator to determine the existence of an actor entity within the geographic area; and
an actor entity system located within the geographic area that receives the legal document from the hub system.

22. The system of claim 21, wherein the hub system includes an input/output for communicating data to and from the actor entity system, and to and from the drafting entity system.

23. The system of claim 21, wherein the hub system includes an actor entity rule subsystem that checks the legal document based on rules of the actor entity system.

24. The system of claim 21, wherein the hub system includes a duplication subsystem that determines whether the legal document is a duplicate.

25. The system of claim 21, wherein the hub system includes a search engine subsystem for accessing at least one service system outside the hub system.

26. The system of claim 25, wherein the at least one service system is chosen from the group comprising: a bankruptcy database service; a government employee database service; a real property database service; a skip search database service; and a law enforcement official database service.

27. The system of claim 22, wherein the hub system includes an expiration system for monitoring expiration of the legal document.
